(19) United States
(12) Patent Application Publication
(10) Pub. No.: US 2011/0279088 A1
(43) Pub. Date: Nov. 17, 2011

(54) BATTERY PACK, DISCHARGE SYSTEM, CHARGE AND DISCHARGE SYSTEM, AND DISCHARGE CONTROL METHOD OF LITHIUM ION SECONDARY BATTERY

(76) Inventors: Taisuke Yamamoto, Nara (JP); Masaya Ugaji, Osaka (JP); Hideharu Takezawa, Nara (JP); Tatsuki Hiraoka, Osaka (JP)

(21) Appl. No.: 13/145,462

(22) PCT Filed: Dec. 1, 2010
(86) PCT No.: PCT/JP2010/007011

§ 371 Date: Jul. 20, 2011

(30) Foreign Application Priority Data
Dec. 16, 2009 (JP) 2009-285211

(51) Int. Cl. H02J 7/04

(52) U.S. Cl. 320/134; 320/136

(57) ABSTRACT

A battery pack includes at least a lithium ion secondary battery, a voltage sensor, and a control unit. The control unit controls discharge of the battery by a relatively high end-of-discharge voltage when the use frequency of the battery is relatively low during discharge of the battery. On the other hand, the control unit controls discharge of the battery by a relatively low end-of-discharge voltage when the use frequency of the battery is relatively high. Consequently, it is possible to prevent the utilizable capacity from decreasing more than a practical decrease in the capacity due to increase in the use frequency.

### TECHNICAL FIELD

The present invention relates to a battery pack, and more specifically relates to control of charge and discharge of a battery pack including a lithium ion secondary battery.

### BACKGROUND ART

In general, charge and discharge of a lithium ion secondary battery are performed within a predetermined voltage range. Specifically, the battery is charged until it reaches a predetermined end-of-charge voltage, and the battery is discharged until it reaches a predetermined end-of-discharge voltage. The charge and discharge are performed by a charge control unit and a discharge control unit in a battery pack or a charge and discharge system including the lithium ion secondary battery.

Patent literature 1 proposes charging and discharging a lithium ion secondary battery including a lithium-containing manganese composite oxide in the positive electrode such that the terminal voltage is varied within the range of 1.5 V to 4.1 V. Consequently, deterioration of the positive electrode can be suppressed. The deterioration of the positive electrode may result in deterioration in the capacity as well as lowering in safety of the battery.

### CITATION LIST

### Patent Literature

[PTL 1] Japanese Laid-Open Patent Publication No. Hei 1-294375

### SUMMARY OF INVENTION

### Technical Problem

It is however insufficient to fix the voltage range for performing the charge and discharge in order to maintain safety and suppress deterioration in the capacity of the lithium ion secondary battery.

In the lithium ion secondary battery, since polarization of the battery increases along with increase in the number of cycles performing the charge and discharge, a closed circuit voltage when measured in the same discharged state (discharge depth) tends to be low. As a result, in the battery pack including the lithium ion secondary battery, when the voltage range for performing the charge and discharge is controlled to a fixed range, an apparent capacity may decrease more than a decrease in the practical capacity along with increase in the number of charge and discharge cycles.

Taking Patent Literature 1 as an example for explanation, Patent Literature 1 performs control of stopping the discharge and starting the charge when the terminal voltage (closed circuit voltage) has dropped to 1.5 V and stopping the charge and starting the discharge when the terminal voltage has risen to 4.1 V. Herein, when the closed circuit voltage lowers along with increase in the number of charge and discharge cycles, as described above, the discharge stops at a stage where the discharge capacity remains sufficiently, which results in a decrease in the apparent capacity of the lithium ion secondary battery.

Meanwhile, if the end-of-discharge voltage is set beforehand to a lower value in anticipating lowering of the terminal voltage due to increase in the number of charge and discharge cycles, the discharge capacity may increase excessively at a stage where the number of charge and discharge cycles is small. In such a case, the crystal structure of the positive electrode active material may be deteriorated significantly, which may lead to deterioration in the cycle characteristics.

Therefore, the present invention aims to provide a battery pack, a discharge system, a charge and discharge system, and a discharge control method of a lithium ion secondary battery that can prevent the capacity from decreasing more than a practical decrease along with increase in the number of charge and discharge cycles and that can prevent deterioration in the cycle characteristics.

### Solution to Problem

The present invention relates to a battery pack comprising:

a lithium ion secondary battery,

a voltage measurement apparatus that measures a terminal voltage of the lithium ion secondary battery;

a discharge control apparatus that controls discharge of the lithium ion secondary battery on the basis of the measured terminal voltage; and

a use frequency detection apparatus that detects a use frequency of the lithium ion secondary battery,

wherein the discharge control apparatus sets an end-of-discharge voltage of the lithium ion secondary battery on the basis of the detected use frequency.

Further, the present invention relates to a control method of controlling discharge of a lithium ion secondary battery, the method comprising the steps of:

(a) detecting a use frequency of the lithium ion secondary battery; and

(b) setting an end-of-discharge voltage of the lithium ion secondary battery on the basis of the detected use frequency.

### Advantageous Effects of Invention

According to the present invention, the end-of-discharge voltage of the lithium ion secondary battery is set on the basis of the detected use frequency (degree of deterioration) of the lithium ion secondary battery. As a result, it is possible to make adjustments such that the end-of-discharge voltage is set to a predetermined value X at an initial use period of the lithium ion secondary battery and that the end-of-discharge voltage is set to a predetermined value Y, which is lower than the predetermined value X, when the use frequency is a predetermined value or more. Therefore, in the initial use period of the lithium ion secondary battery, it is possible to prevent deterioration in the cycle characteristics of the lithium ion secondary battery by setting the end-of-discharge voltage to a relatively high value such that the discharge capacity is not excessively large. Meanwhile, when the terminal voltage has dropped due to increase in the number of charge and discharge cycles, it is possible to prevent the utilizable capacity of the lithium ion secondary battery from decreasing more than a decrease in the practical capacity by setting the end-of-discharge voltage to a relatively low value.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A circuit diagram illustrating a schematic configuration of a charge and discharge system including a battery pack in accordance with an embodiment of the present invention.

FIG. 2 A graph showing the relation between the terminal voltage and the discharge capacity ratio of a conventional lithium ion secondary battery in accordance with the number of charge and discharge cycles and the discharge rate.

FIG. 3 A conceptual diagram of end-of-discharge voltage-related information used in the system of FIG. 1.

FIG. 4 A flowchart of discharge control in the above system.

### DESCRIPTION OF EMBODIMENTS

In the following, embodiments of the present invention will be described by referring to drawings.

### Embodiment 1

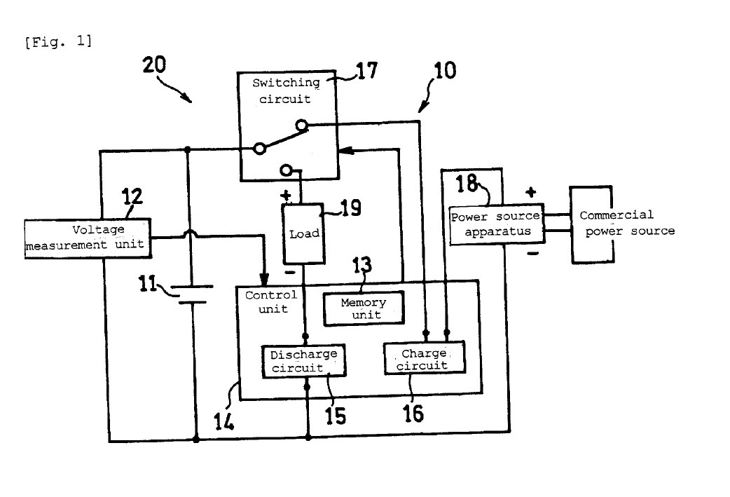

FIG. 1 is a circuit diagram illustrating a schematic configuration of a battery pack and a charge and discharge system including the battery pack in accordance with an embodiment of the present invention.

A battery pack 10 includes a lithium ion secondary battery (battery, hereinafter) 11, a voltage measurement unit 12 that detects terminal voltage of the battery 11, a control unit 14 that controls charge and discharge of the battery 11, and a switching circuit 17. The control unit 14 includes a memory unit 13, a discharge circuit 15, and a charge circuit 16. Although the control unit 14 serves both as a discharge control apparatus and as a charge control apparatus, the charge control apparatus may be configured as a component separate from the battery pack 10. Also, the charge circuit 16 may be included in the charge control apparatus which is a component separate from the battery pack 10. The voltage measurement unit 12 corresponds to a voltage measurement apparatus and the control unit 14 corresponds to a use frequency detection apparatus and a discharge control apparatus.

Also, the battery pack 10 forms a charge and discharge system 20 together with load equipment 19 that consumes electric power supplied from the battery pack 10. The charge circuit 16 can be connected with a power source apparatus 18. The power source apparatus 18 is composed of a so-called AC adapter etc. and can be connected with an outer power source such as a commercial power source. The load equipment 19 can be a cellular phone, a personal computer, portable game equipment, and mobile equipment (electric vehicle etc.).

In practice, although operation of supplying electric power to the load equipment 19 from the power source apparatus 18 while charging the battery 11 is also performed, the figure illustrates herein a wiring in which the load equipment 19 receives supply of electric power only from the battery 11 in order to simplify the explanation.

The battery 11 is connected in parallel with the voltage measurement unit 12. The discharge circuit 15 and the charge circuit 16 include a pair of terminals, respectively.

A positive terminal of the battery 11 is connected with the switching circuit 17, and a negative terminal of the battery 11 is connected with one terminal of the discharge circuit 15 and with a negative terminal of the power source apparatus 18. The other terminal of the discharge circuit 15 is connected with a negative side terminal of the load equipment 19. A positive terminal of the power source apparatus 18 is connected with one terminal of the charge circuit 16. The other terminal of the charge circuit 16 is connected with the switching circuit 17. A positive side terminal of the load equipment 19 is connected with the switching circuit 17.

The switching circuit 17 includes a discharge switch that controls connection between the positive terminal of the battery 11 and the positive side terminal of the load equipment 19, and a charge switch that controls connection between the positive terminal of the battery 11 and the other terminal of the charge circuit 16.

When the discharge switch is turned on, the charge switch is turned off, and the positive terminal of the battery 11 is connected with the positive side terminal of the load equipment 19. When the discharge switch is turned off, the connection is cut off.

Meanwhile, when the charge switch is turned on, the discharge switch is turned off, and the positive terminal of the battery 11 is connected with the other terminal of the charge circuit 16. When the charge switch is turned off, the connection is cut off.

Also, when both of the discharge switch and the charge switch are turned off, the battery 11 is connected in parallel with only the voltage measurement unit 12.

In the above configuration, when the discharge switch of the switching circuit 17 is turned on, the battery 11 is connected with the load equipment 19, and electric power is supplied to the load equipment 19 from the battery 11.

On the other hand, when the charge switch of the switching circuit 17 is turned on, the battery 11 is connected in parallel with the power source apparatus 18, and the battery 11 is charged.

The control unit 14 includes an arithmetical apparatus such as an IC, a CPU, and a microcomputer. The control unit 14 inputs information about the terminal voltage of the battery 11 measured by the voltage measurement unit 12.

The memory unit 13 of the control unit 14 is composed of a RAM, a ROM (including a flash memory) etc. and memorizes the end-of-charge voltage of the battery 11 and information about the relation between the use frequency and the end-of-discharge voltage of the battery 11 (end-of-discharge voltage-related information). In the end-of-discharge voltage-related information of the system of FIG. 1, when the use frequency of the battery 11 is relatively low, the end-of-discharge voltage is set to a relatively high voltage, and when the use frequency of the battery 11 is relatively high, the end-of-discharge voltage is set to a relatively low voltage.

The end-of-charge voltage and the end-of-discharge voltage-related information that are memorized in the memory unit 13 are read out from the memory unit 13 by the arithmetical apparatus when the charge and discharge of the battery 11 are performed. In a charge mode (state where the charge switch is on), the arithmetical apparatus refers to the end-of-charge voltage that has been read out, performs a constant current charge until the terminal voltage of the battery 11 measured by the voltage measurement unit 12 reaches the end-of-charge voltage, and subsequently performs a constant voltage charge. In the constant voltage charge, when the current value has dropped to a predetermined cut-off current, the charge of the battery 11 is stopped, and the charge and discharge system 1 is switched to a discharge mode (state where the discharge switch is on).

On the other hand, in the discharge mode, the arithmetical apparatus refers to the end-of-discharge voltage-related information that is read out and performs discharge until the terminal voltage of the battery 11 measured by the voltage measurement unit 12 reaches the end-of-discharge voltage that is set according to the use frequency of the battery 11 by the end-of-discharge voltage-related information. When the terminal voltage of the battery 11 reaches the end-of-discharge voltage, the discharge of the battery 11 is stopped and the charge and discharge system 1 is switched to the charge mode (state where the charge switch is on).

In the system of FIG. 1, the end-of-discharge voltage is set according to the use frequency of the battery 11 for the following reason.

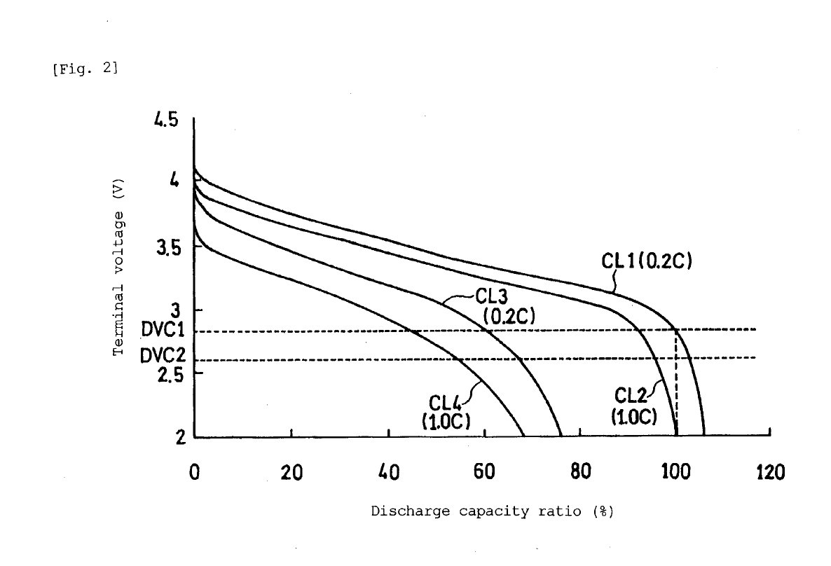

FIG. 2 shows the relation between the discharge capacity ratio (percentage to predetermined discharge capacity) and the terminal voltage in a conventional lithium ion secondary battery.

In the figure, a curved line CL1 shows the relation between the terminal voltage and the discharge capacity ratio when the lithium ion secondary battery is discharged at a charge rate of 0.2 C from a fully charged state in an initial period of a charge and discharge cycle test of 200 cycles. Also, a curved line CL2 shows the relation between the terminal voltage and the discharge capacity ratio when the lithium ion secondary battery is discharged at a charge rate of 1.0 C from a fully charged state in an initial period of a charge and discharge cycle test of 200 cycles.

A curved line CL3 shows the relation between the terminal voltage and the discharge capacity ratio when the lithium ion secondary battery is discharged at a discharge rate of 0.2 C from a fully charged state after a charge and discharge cycle test of 200 cycles. A curved line CL4 shows the relation between the terminal voltage and the discharge capacity ratio when the lithium ion secondary battery is discharged at a discharge rate of 1.0 C from a fully charged state after a charge and discharge cycle test of 200 cycles.

As shown in FIG. 2, the terminal voltage of the lithium ion secondary battery drops rapidly when it reaches to a predetermined discharge capacity ratio. Also, the lower the discharge rate is, the higher the terminal voltage is even when the discharge capacity ratio is the same.

In the example of FIG. 2, as shown by the curved line CL1, the end-of-discharge voltage (DVC1) is set to about 2.8 V such that the discharge capacity ratio does not exceed 100% even when the discharge rate is 0.2 C.

In the curved lines CL3 and CL4 after the cycle test, even when the discharge capacity ratio is the same, the terminal voltage lowers greatly as compared with the curved lines CL1 and CL2. This is because when the number of charge and discharge cycles increases, the internal resistance of the lithium ion secondary battery increases. For this reason, when the initial value DVC1 is used as it is as the end-of-discharge voltage, the discharge stops at the point of time when dischargeable quantity of electricity still remains. As a result, the utilizable capacity decreases more than the practical capacity.

Therefore, in the system of FIG. 1, when the use frequency of the battery 11 increases to a certain degree or more, the end-of-discharge voltage is reset to a voltage DVC2 (about 2.6 V in the figure) that is lower than the initial value DVC1. Consequently, it is possible to prevent the utilizable capacity from decreasing more than the decrease in the practical capacity even when the number of charge and discharge cycles increases and the internal resistance increases in the lithium ion secondary battery. Thus, the capacity of the lithium ion secondary battery can be utilized effectively.

Herein, a difference Z between the initial set value DVC1 of the end-of-discharge voltage and the end-of-discharge voltage DVC2 when the use frequency of the lithium ion secondary battery comes to a predetermined value or more (late stage set value, hereinafter) is preferably within the range of 0.005 to 1.0 V. This is because when the difference Z is smaller than 0.005 V, the effect of utilizing effectively the capacity is hardly exhibited. On the other hand, when the difference Z exceeds 1.0 V, change in the structure of the active material and side reactions are facilitated to shorten battery life, which all the more leads to a decrease in the capacity. More preferable range of the difference Z between the initial set value DVC1 and the late stage set value DVC2 is 0.05 to 0.5 V.

As described above, when the use frequency of the battery 11 increases, the internal resistance of the battery 11 increases. Therefore, for detecting the use frequency of the battery 11, for example, polarization voltage is detected from the difference of voltage ΔV1 between the open circuit voltage OCV and the closed circuit voltage CCV of the battery 11 in the fully-charged state (state where the open circuit voltage is the predetermined maximum terminal voltage), and the use frequency can be detected on the basis of the detected polarization voltage.

In this case, when the difference of voltage ΔV1 reaches to a predetermined value A, control of switching the end-of-discharge voltage from DVC1 to DVC2 is done. Herein, the predetermined value A is preferably within the range of 0.005 to 1.0 V. More preferable range of the predetermined value A is 0.01 to 0.8 V.

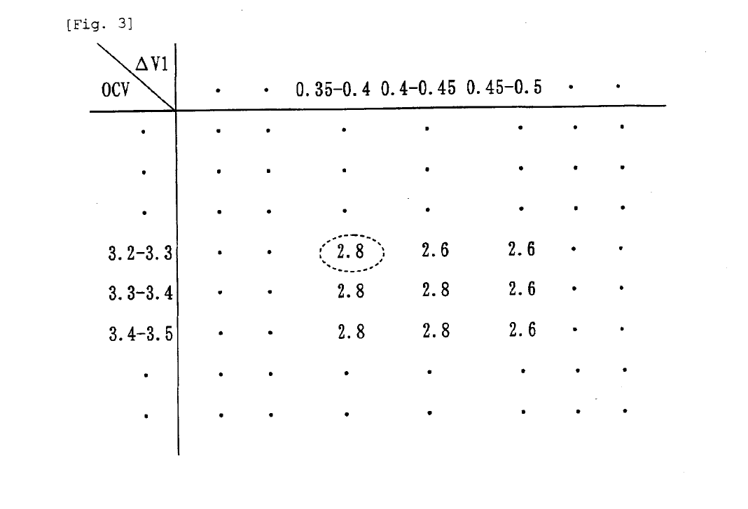

In the memory unit 13 of the system of FIG. 1, as shown in FIG. 3, the end-of-discharge voltage-related information is memorized as data in a table form showing end-of-discharge voltages corresponding to combinations of ranges of the open circuit voltage OCV and ranges of the difference of voltage ΔV1. In the example of FIG. 3, for example, the end-of-discharge voltage is set to 2.8 V (value surrounded by an oval broken line in the figure) when OCV is 3.2 V or more and less than 3.3 V, and ΔV1 is 0.35 V or more and less than 0.4 V.

Thus, by setting the end-of-discharge voltage corresponding to combination of the range of the difference of voltage ΔV1 and the range of the open circuit voltage OCV, it is possible to modify setting to more appropriate end-of-discharge voltage as necessary even when the battery 11 is not in the fully charged state.

In place of this constitution, the end-of-discharge voltage can be set every time when the battery 11 comes to a fully charged state according to the difference of voltage ΔV1 then. In this case, the previous end-of-discharge voltage is used between the time when the battery 11 comes to a fully charged state and an end-of-discharge voltage is set once and the next time when the battery 11 comes to a fully charged state and a new end-of-discharge voltage is set.

The switching of the end-of-discharge voltage as above can be performed not only once but also twice or more. In this case, two or more predetermined value A1, A2 . . . and two or more end-of-discharge voltages for switching should be prepared.

Next, operation of the system of FIG. 1 will be described by referring to a flowchart.

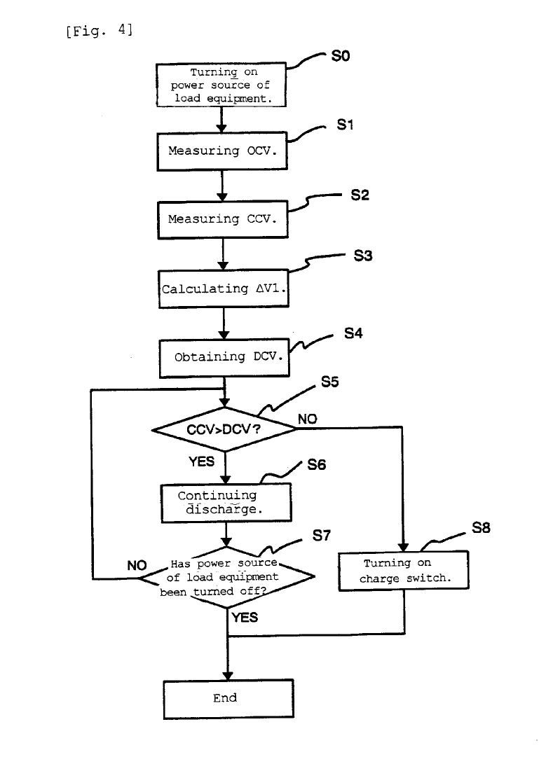

FIG. 4 is a flowchart of discharge control performed by the control unit 14 in the discharge mode.

When the power source switch of the load equipment 19 is turned on by a user, the load equipment 19 is started (SO). Then, both the charge switch and the discharge switch of the switching circuit 17 are turned off, and in this state, the voltage measurement unit 12 measures the terminal voltage of the battery 11 (S1). Consequently, the open circuit voltage (OCV) of the battery 11 is detected.

Next, the discharge switch of the switching circuit 17 is turned on and the supply of electric power to the load equipment 19 is started. Then, the terminal voltage of the battery 11 after a lapse of a predetermined time (e.g. 10 seconds) from the time when the discharge switch is turned on is measured by the voltage measurement unit 12 (S2). Thus, the closed circuit voltage (CCV) of the battery 11 is detected. The above predetermined time is set appropriately according to practically consumed electric power of the load equipment 19. For example, it is set in the range of 0.1 seconds to 15 minutes.

Next, the difference of voltage ΔV1 between OCV and CCV is calculated (S3). The measured CCV and the calculated ΔV1 are collated with the end-of-discharge voltage-related information that is memorized in the memory unit 13, whereby corresponding end-of-discharge voltage (DCV) is obtained (S4). The obtained DCV and the measured CCV are compared (S5). If the result is CCV>DCV, the battery 11 is judged not have been discharged to the end-of-discharge voltage, and the discharge is continued until CCV becomes equal to DCV (S6).

Next, whether the power source switch of the load equipment 19 has been turned off or not is judged (S7), and if it has been turned off, the process is ended. If the power source switch of the load equipment 19 has not been turned off, the process is returned to the step S5.

Meanwhile, if the result of the comparison in the step S5 is CCV≦DCV, the battery 11 is judged to have been discharged to the end-of-discharge voltage, and the charge switch is turned on (S8). Consequently, the discharge switch is turned off and the discharge of the battery 11 is stopped. Herein, if the power source apparatus 18 is connected with the outer power source, the charge of the battery 11 is started.

As described above, it is possible to set the end-of-discharge voltage of the battery 11 according to the use frequency of the battery 11 and perform discharge control of the battery 11 according to the end-of-discharge voltage that has been set.

As shown in FIG. 2, the discharge curve of the lithium ion secondary battery also changes by the discharge current (load). Therefore, it is preferable that the end-of-discharge voltage DVC obtained in the step S4 is revised according to the discharge rate. Alternatively, the end-of-discharge voltage corresponding to each range of ΔV1 and OCV may be memorized in the memory unit 13 at each discharge rate. Specifically, it is preferable to revise such that the lower the discharge current value is, that is, the lower the discharge rate is, the higher the end-of-discharge voltage is.

In a more preferable mode of the present embodiment, the positive electrode includes a lithium-containing composite oxide as a positive electrode active material. It is preferable that the lithium-containing composite oxide has a hexagonal layered structure or a spinel-type crystal structure. Such a lithium-containing composite oxide has a high capacity and has a high potential with respect to metal lithium. Therefore, a lithium ion battery having a high capacity can be realized. In particular, a lithium-containing nickel composite oxide is preferable as the positive electrode active material because the positive electrode active material mainly composed of nickel has a particularly high capacity.

In the lithium-containing nickel composite oxide, the molar ratio of Ni to Li is preferably 10% by mol or more, and more preferably 50 to 100% by mol. It is preferable that the lithium-containing nickel composite oxide further includes at least one selected from the group consisting of manganese, cobalt, and aluminum. When the lithium-containing nickel composite oxide includes manganese, the molar ratio of Mn to Li is preferably 10 to 40% by mol. When the lithium-containing nickel composite oxide includes cobalt, the molar ratio of Co to Li is preferably 5 to 40% by mol. When the lithium-containing nickel composite oxide includes aluminum, the molar ratio of Al to Li is preferably 0.5 to 30% by mol. In particular, the present invention is greatly effective when the lithium-containing nickel composite oxide including cobalt and aluminum is used because the lithium-containing nickel composite oxide including cobalt and aluminum causes change in the discharge capacity by temperature and readily causes deterioration in the crystal structure when overdischarged.

In the preferable embodiment of the present invention, the negative electrode includes a carbon material or an alloy-type active material. Also, it is desirable that lithium corresponding to a irreversible capacity has been absorbed in the negative electrode before assembly of the battery. In this case, since the irreversible capacity of the positive electrode is larger than the irreversible capacity of the negative electrode, the need for suppressing deterioration of the positive electrode by preventing overdischarge is significant, as described above.

Examples of the carbon material include graphite, graphitizable carbon material, and non-graphitizable carbon material.

The alloy-type active material is a material that absorbs lithium ions by alloying with lithium and that reversibly absorbs and desorbs lithium ions under negative electrode potential. As the alloy-type active material, silicon-based active materials and tin-based active materials etc. are preferable. The silicon-based active materials include silicon, silicon compounds, partially replaced silicon compounds, and solid solutions of silicon compounds. The silicon compounds include silicon oxides represented by the formula: SiOₐ (0.05<a<1.95), silicon carbides represented by the formula: SiC_{b} (0<b<1), and silicon nitrides represented by the formula: SiN_{C} (0<c<4/3), and silicon alloys. The silicon alloys are alloys of silicon with different elements A. Examples of the different elements A include Fe, Co, Sb, Bi, Pb, Ni, Cu, Zn, Ge, In, Sn, and Ti.

### Embodiment 2

Next, Embodiment 2 of the present invention will be described. Since Embodiment 2 has the same configuration as that of Embodiment 1, drawings referred to in Embodiment 1 is used for explanation.

The difference of Embodiment 2 from Embodiment 1 is the point that the use frequency of the battery 11 is detected by the internal resistance, not by the difference of voltage ΔV1 between the open circuit voltage (OCV) and the closed circuit voltage (CCV).

As a method of detecting the internal resistance of the battery 11, there is a method of detecting the internal resistance by generating a predetermined pulse current from the battery 1 and detecting the internal resistance on the basis of a current value Iₚᵤₗ and a change amount ΔV2 in the terminal voltage (OCV) of the battery 11 measured by the voltage measurement unit 12. The ratio R of the change amount ΔV2 to the current value Iₚᵤₗ is compared with a predetermined value B from the relation of current×resistance=voltage, and if the ratio R is smaller than the predetermined value B, the use frequency of the battery 11 is considered to be relatively low, and a relatively high end-of-discharge voltage (DVC1) is set. If the ratio R is the predetermined value B or more, the use frequency of the battery 11 is considered to be relatively high, and a relatively low end-of-discharge voltage (DVC2) is set.

Herein, the predetermined value B is set preferably in the range of 0.01 mΩ to 0.5Ω. More preferable range of the predetermined value B is 1 to 200 mΩ.

In this case, the memory unit 13 memorizes information combining at least two ranges of the ratio R and the end-of-discharge voltage corresponding to each range as the end-of-discharge voltage-related information.

Also, in place of the steps S1 to S4 of FIG. 4, the change amount ΔV2 in the terminal voltage (OCV) of the battery 11 at the time of applying the pulse current of current value Iₚᵤₗ is calculated on the basis of the measurement results of the voltage measurement unit 12. The ratio R is calculated from the current value Iₚᵤₗ and the change amount ΔV2, and the end-of-discharge voltage (DCV) is determined by collating the calculated ratio R with the end-of-discharge voltage-related information. Other processes are the same as in Embodiment 1.

As described above, the use frequency of the battery 11 can also be detected by detecting the internal resistance of the battery 11, and the same effects as in Embodiment 1 can be obtained in this case. Also in this case, switching of the end-of-discharge voltage can be performed not only once but also twice or more.

### Embodiment 3

Next, Embodiment 3 of the present invention will be described. Since Embodiment 3 has the same configuration as that of Embodiment 1, drawings referred to in Embodiment 1 is used for explanation.

Embodiment 3 is different from Embodiment 1 in the point that the use frequency of the battery 11 is detected by the change of the open circuit voltage from the initial value.

As a method of detecting the use frequency of the battery 11 by the change of the open circuit voltage from the initial value, there is a method of comparing the open circuit voltage of the battery 11 in the same charged state (charge depth). For example, when the battery 11 is in the fully charged state, the open circuit voltage (OCV_{PV}) of the battery 11 is measured, and the measured value OCV_{PV} is compared with the open circuit voltage measured in the initial use period (OCV_{SV}, initial open circuit voltage, hereinafter) of the battery 11 under the same conditions.

That is, a difference ΔV3 between OCV_{PV} and OCV_{SV} is calculated, and if the difference ΔV3 is smaller than a predetermined value C, the use frequency of the battery 11 is considered to be relatively low, and a relatively high end-of-discharge voltage (DVC1) is set. If the difference ΔV3 is the predetermined value C or more, the use frequency of the battery 11 is considered to be relatively high, and a relatively low end-of-discharge voltage (DVC2) is set. Herein, the predetermined value C is set to 0.005 to 0.5 V, preferably 0.01 to 0.3 V.

In this case, the memory unit 13 memorizes information combining at least two ranges of the difference ΔV3 and the end-of-discharge voltage corresponding to each range, and the initial open circuit voltage OCV_{SV} as the end-of-discharge voltage-related information.

Further, in place of the steps S1 to S4 in FIG. 4, the difference ΔV3 is calculated from OCV_{SV} and OCV_{PV}, and the calculated difference ΔV3 is collated with the end-of-discharge voltage-related information to determine the end-of-discharge voltage (DCV). Other processes are the same as in Embodiment 1.

As described above, the use frequency of the battery 11 can be detected by detecting the open circuit voltage of the battery 11 in the fully charged state, and in this case, the same effects can be obtained as in Embodiment 1. Also, in this case, switching of the end-of-discharge voltage can be performed not only once but also twice or more.

Next, the present invention will be described more specifically by referring to Examples. It is to be noted that the present invention is not limited to the following Examples.

### Example 1

### (1) Production of Positive Electrode

As the positive electrode active material, LiNi_{0.85}Co_{0.15}Al_{0.05}O₂ that is a lithium-containing nickel composite oxide including cobalt and aluminum was used.

85 parts by weight of the positive electrode active material, 10 parts by weight of carbon powder as a conductive agent, and an N-methyl-2-pyrrolidone solution of polyvinylidene fluoride (PVDF) as a binder were mixed to obtain a positive electrode material mixture paste. The amount of PVDF was 5 parts by weight. The obtained positive electrode material mixture paste was applied onto one surface of an aluminum foil (positive electrode current collector 20) having a thickness of 15 μm, which was then dried and rolled to produce a positive electrode having a thickness of 70 μm.

The obtained positive electrode was cut so as to have an active material applied portion of 20 mm square and dispose a lead fixing portion of 5 mm square on an end portion.

### (2) Production of Negative Electrode

A copper alloy foil provided with numerous protruding portions having a maximum height of about 8 μm that are formed at predetermined intervals on both surfaces was used as the negative electrode current collector. A silicon oxide SiO_{0.2} was vapor deposited on one surface of the negative electrode current collector to form a negative electrode active material layer. A vapor deposition apparatus available from ULVAC, Inc. was used, and the active material layer was formed by forming columnar bodies having 50 particle layers respectively on the numerous protruding portions.

Conditions of vapor deposition were as follows:

Raw material of negative electrode active material (vaporization source 35): silicon, 99.9999% purity, available from Kojundo Chemical Laboratory Co., Ltd.

Oxygen discharged from nozzle 34: 99.7% purity, available from Nippon Sanso Corporation

Oxygen discharge flow rate from nozzle 34: 80 sccm

Angle α: 60°

Acceleration voltage of electron beam: −8 kV

Emission: 500 mA

Vapor deposition time: 3 minutes

A cross section in the thickness direction of the negative electrode was observed with a scanning electron microscope, and in each of 10 columnar bodies formed respectively on 10 protruding portions, the length from the top of the protruding portion to the top of the columnar body was determined. An average value (16 μm) of 10 measured values was defined as the thickness of the negative electrode active material layer. Amount of oxygen included in the columnar bodies was quantified by combustion method, and the composition of the compound forming the columnar bodies was found to be SiO_{0.2}.

Next, lithium metal was vapor deposited on the surface of the negative electrode active material layer. By vapor depositing lithium metal, lithium corresponding to an irreversible capacity stored in the first charge and discharge was supplied to the negative electrode active material layer. Lithium metal was vapor deposited in an argon atmosphere by using a resistance heat vapor deposition apparatus (available from ULVAC, Inc.). Lithium metal was loaded on a boat made of tantalum in the resistance heat vapor deposition apparatus. The negative electrode was fixed such that the negative electrode active material layer faces the boat made of tantalum. An electric current of 50 A was applied to the boat made of tantalum and vapor deposition was performed for 10 minutes.

The obtained negative electrode was cut so as to have an active material forming portion of 21 mm square and dispose a lead fixing portion of 5 mm square.

### (3) Preparation of Non-Aqueous Electrolyte

LiPF₆ was dissolved at a concentration of 1.2 mol/L in a solvent mixture of ethylene carbonate, ethylmethyl carbonate, and diethyl carbonate having a volume ratio of 2:3:5, whereby a non-aqueous electrolyte is prepared. 5 parts by weight of vinylene carbonate was added to 100 parts by weight of the non-aqueous electrolyte.

### (4) Assembly of Battery

First, a microporous film made of polyethylene (thickness 20 μm, available from Asahi Kasei Corporation) was interposed as a separator between the positive electrode active material layer of the positive electrode and the negative electrode active material layer of the negative electrode to produce a laminate type electrode group. Next, an end of a positive electrode lead made of aluminum was welded to the positive electrode current collector and an end of a negative electrode lead made of nickel was welded to the negative electrode current collector. The electrode group was housed in an outer case made of an aluminum laminate sheet together with the non-aqueous electrolyte. Next, the positive electrode lead and the negative electrode lead were led from an opening of the outer case and the opening of the outer case was welded with resin while vacuum decompressing the inside.

### (5) Evaluation

(a) The obtained battery was charged in an environment at 25° C. under charge conditions 1 as described below and was subsequently discharged under discharge conditions 1, and the discharge capacity was determined. The obtained value was defined as an initial capacity.

(b) A charge and discharge test repeating charge under charge conditions 1 in an environment at 45° and discharge under discharge conditions 2 was performed. From charge and discharge data, a difference ΔV1 between the open circuit voltage (OCV) in the fully charged state and the closed circuit voltage (CCV) after 60 seconds of application of electric current was calculated.

(c) When the calculated ΔV1 reached 0.3 V (time when charge process at about 200th cycle was finished), the discharge conditions were switched to discharge conditions 3, and further, charge and discharge process of 100 cycles was performed. Then, capacity retention rate after cycle test to the initial capacity obtained in (a) was calculated to be 86%.

Charge conditions 1: constant current—constant voltage charge (constant current charge (charge rate: 0.3 C, end-of-charge voltage: 4.2 V), constant voltage charge (cutoff: 0.05 C), temperature: 25° C.)

Discharge conditions 1: constant current discharge (discharge rate: 1 C, end-of-discharge voltage 2.50 V, temperature: 25° C.)

Discharge conditions 2: constant current discharge (discharge rate: 1 C, end-of-discharge voltage 2.75 V, temperature: 45° C.)

Discharge conditions 3: constant current discharge (discharge rate: 1 C, end-of-discharge voltage 2.65 V, temperature: 45° C.)

Discharge conditions 4: constant current discharge (discharge rate: 1 C, end-of-discharge voltage 2.5 V, temperature: 45° C.)

### Comparative Example 1

An initial capacity of the battery was determined by the above procedure (a) in the same manner as in Example 1. Also, a charge and discharge test repeating charge under charge conditions 1 in an environment at 45° C. and discharge under discharge conditions 4 was repeated for 300 times. A capacity retention rate after 300 cycles was calculated in the same manner as in Example 1, and it was 75%.

As clear from the above results, the capacity retention rate is improved significantly in Example 1 as compared to Comparative Example 1. Consequently, according to the present invention, it is possible to prevent the utilizable capacity from decreasing more than a decrease in the practical capacity when the capacity of the lithium ion secondary battery is decreased along with increase in the number of charge and discharge cycles.

### INDUSTRIAL APPLICABILITY

The present invention is suitably applied to the lithium ion secondary battery requiring further higher capacity because the end-of-discharge voltage is set reasonably so as to fit discharge characteristics of the lithium ion secondary battery.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 Battery pack
11 Lithium ion secondary battery
12 Voltage measurement unit
14 Control unit
19 Load equipment
20 Charge and discharge system

1. A battery pack comprising:
a lithium ion secondary battery;
a voltage measurement apparatus that measures a terminal voltage of said lithium ion secondary battery;
a discharge control apparatus that controls discharge of said lithium ion secondary battery on the basis of said measured terminal voltage; and
a use frequency detection apparatus that detects a use frequency of said lithium ion secondary battery,
wherein said discharge control apparatus sets an end-of-discharge voltage of said lithium ion secondary battery on the basis of said detected use frequency.

2. The battery pack in accordance with claim 1,
wherein said use frequency detection apparatus detects a polarization voltage from a difference ΔV1 between an open circuit voltage and a closed circuit voltage of said lithium ion secondary battery, and
said use frequency detection apparatus detects said use frequency on the basis of said detected polarization voltage.

3. The battery pack in accordance with claim 2,
wherein said control apparatus sets said end-of-discharge voltage to a predetermined value X when said difference ΔV1 is less than a predetermined value A, and
said control apparatus sets said end-of-discharge voltage to a predetermined value Y (X>Y) when said difference ΔV1 is the predetermined value A or more.

4. The battery pack in accordance with claim 3, wherein said predetermined value A is 0.005 to 1.0 V.

5. The battery pack in accordance with claim 1,
wherein said use frequency detection apparatus applies a predetermined pulse current to said lithium ion secondary battery,
said use frequency detection apparatus detects an internal resistance of said lithium ion secondary battery on the basis of a current value I of said pulse current and a change amount ΔV2 of voltage measured by said voltage measurement apparatus when said pulse current is applied, and
said use frequency detection apparatus detects said use frequency on the basis of said detected internal resistance.

6. The battery pack in accordance with claim 5,
wherein said control apparatus sets said end-of-discharge voltage to a predetermined value X when a ratio R of said change amount AV2 to said current value I is less than a predetermined value B, and
said control apparatus sets said end-of-discharge voltage to a predetermined value Y (X>Y) when said ratio R is the predetermined value B or more.

7. The battery pack in accordance with claim 6, wherein said predetermined value B is 0.01 mΩ to 0.5Ω.

8. The battery pack in accordance with claim 1, wherein said use frequency detection apparatus detects said use frequency on the basis of a change amount ΔV3 from an initial value of an open circuit voltage measured by said voltage measurement apparatus when said lithium ion secondary battery is in a fully charged state.

9. The battery pack in accordance with claim 8,
wherein said control apparatus sets said end-of-discharge voltage to a predetermined value X when said change amount ΔV3 of said open circuit voltage is less than a predetermined value C, and
said control apparatus sets said end-of-discharge voltage to a predetermined value Y (X>Y) when said change amount of said open circuit voltage is the predetermined value C or more.

10. The battery pack in accordance with claim 9, wherein said predetermined value C is 0.005 to 0.5 V.

11. The battery pack in accordance with claim 3, wherein a difference Z between said predetermined value X and said predetermined value Y is 0.005 to 1.0 V.

12. A discharge system comprising:
the battery pack in accordance with claim 1; and
load equipment that consumes electric power supplied from said lithium ion secondary battery.

13. A charge and discharge system comprising:
the battery pack in accordance with claim 1;
a charge control apparatus that controls charge of said lithium ion secondary battery; and
load equipment that consumes electric power supplied from said lithium ion secondary battery.

14. The discharge system in accordance with claim 12, wherein said load equipment is at least one selected from the group consisting of cellular phones, personal computers, portable game equipment, and mobile equipment.

15. The charge and discharge system in accordance with claim 13, wherein said load equipment is at least one selected from the group consisting of cellular phones, personal computers, portable game equipment, and mobile equipment.

16. A control method of controlling discharge of a lithium ion secondary battery, said method comprising the steps of:
(a) detecting a use frequency of said lithium ion secondary battery; and
(b) setting an end-of-discharge voltage of said lithium ion secondary battery on the basis of said detected use frequency.

17. The control method in accordance with claim 16, wherein said step (a) comprises the steps of:
(c) measuring an open circuit voltage of said lithium ion secondary battery in a predetermined charged state;
(d) measuring a closed circuit voltage of said lithium ion secondary battery in said predetermined charged state;
(e) calculating a difference ΔV1 between said measured open circuit voltage and said measured closed circuit voltage of said lithium ion secondary battery; and
(f) obtaining an end-of-discharge voltage corresponding to said difference ΔV1 by collating said calculated difference ΔV1 with end-of-discharge voltage-related information that is set beforehand.
